(19) United States
(12) Patent Application Publication
(10) Pub. No.: US 2006/0183242 A1
(43) Pub. Date: Aug. 17, 2006

(54) Phthalate polymers

(75) Inventors: Wenxi Huang, Fremont, CA (US); Aaron Chen, Irvine, CA (US); Sarah Ngola, Sunnyvale, CA (US); Kamen Voivodov, Hayward, CA (US)

Correspondence Address: MORGAN LEWIS & BOCKIUS LLP, TWO PALO ALTO SQ, 3000 EL CAMINO REAL STE 700, PALO ALTO, CA, 94306, US

(73) Assignee: Ciphergen Biosystems, Inc., Fremont, CA (US)

(21) Appl. No.: 11/057,880

(22) Filed: Feb. 14, 2005

(51) Int. Cl. G01N 31/22

(52) U.S. Cl. 436/166; 422/56

(57) ABSTRACT

Polymers bearing metal chelating groups are readily prepared from easily accessible precursors. The polymers are readily converted to the corresponding metal chelates. The polymers can also include an energy absorbing moiety for use in matrix assisted laser desorption/ionization mass spectrometry. The polymer can also include a photo-curable group, which can be used to form cross-links within the bulk polymer or between the polymer and a surface functionalized with a polymerizable moiety. The polymers are incorporated into devices of use for the analysis, capture, separation, or purification of an analyte. In an exemplary embodiment, the invention provides a substrate coated with a polymer of the invention, the substrate being adapted for use as a probe for a mass spectrometer.

### BACKGROUND OF THE INVENTION

Laser desorption mass spectrometry is a particularly useful tool for detecting proteins. SELDI is a method of laser desorption mass spectrometry in which the surface of a mass spectrometry probe plays an active part in the analytical process, either through capture of the analytes through selective adsorption onto the surface (“affinity mass spectrometry”), or through assisting desorption and ionization through attachment of energy absorbing molecules to the probe surface (“surface-enhanced neat desorption” or “SEND”). These methods are described in the art. See, for example, U.S. Pat. No. 5, 719,060 and 6,225,047, both to Hutchens and Yip.

Probes with functionalized surfaces for SELDI also are known in the art. International publication WO 00/66265 (Rich et al., “Probes for a Gas Phase Ion Spectrometer,” Nov. 9, 2000) describes probes have surfaces with a hydrogel attached functionalized for adsorption of analytes. U.S. patent application US 2003-0032043 A1 (Pohl and Papanu, “Latex Based Adsorbent Chip,” Jul. 16, 2002) describes a probe whose surfaces comprises functionalized latex particles. U.S patent application US 2003-0124371 (Um et al., Jul. 3, 2003) describes a chip with a hydrophobic surface coating. U.S. patent application US 2003-0218130 A1 (Boschetti et al., Nov. 27, 2003) describes biochips with surfaces coated with polysaccharide-based hydrogels. International patent application WO 04/07651 1A2 (Huang et al., Sep. 10, 2004) describes photocrosslinked hydrogel surface coatings.

An effective functionalized material for bioassay applications must have adequate capacity to immobilize a sufficient amount of an analyte from relevant samples in order to provide a suitable signal when subjected to detection (e.g., mass spectroscopy analysis). Suitable functionalized materials must also provide a highly reproducible surface in order to be gainfully applied to profiling experiments, particularly in assay formats in which the sample and the control must be analyzed on separate adsorbent surfaces, e.g. adjacent chip surfaces. For example, chips that are not based on a highly reproducible surface chemistry result in significant errors when undertaking assays (e.g., profiling comparisons).

The need in the art for new functionalized materials, devices incorporating the materials and methods of forming such materials is illustrated by reference to devices that include a hydrogel component. In general devices that include a hydrogel are formed by the in situ polymerization of the hydrogel on a substrate, e.g., bead, particle, plate, etc.

Thus, there is a need for functionalized materials and devices including these materials that provide reproducible results from assay to assay, are easy to use, and provide quantitative data in multi-analyte systems. Moreover, to become widely accepted, the materials should be inexpensive and simple to make, exhibit low non-specific binding, and be able to be formed into a variety of functional device formats. The availability of a device incorporating a material having the above-described characteristics would significantly affect research, diagnostics (reference lab, point of care, etc.), and high throughput testing applications. The present invention provides functionalized materials having these and other desirable characteristics.

### BRIEF SUMMARY OF THE INVENTION

The utility and versatility of analyses using polymeric surfaces that interact with an analyte can be enhanced by the use of polymers of different formats that bind to a selected analyte under different conditions. For example, when the polymer has metal chelating properties, it is generally desired to select conditions for an analysis under which the interaction between the metal chelate groups on the polymer and a selected analyte are optimized and non-specific interactions between the polymer and contaminants, or species irrelevant to the analysis, are minimized. In general, this result can be obtained by optimizing the metal chelating properties of the analyte, thereby maximizing the interaction between the analyte and the metal chelating polymer.

Many systems have been developed in recent years for the rapid purification of recombinant proteins. An efficient method relies on specific interactions between an affinity tag (usually a short peptide with specific molecular recognition properties, e.g., maltose binding protein, thioredoxin, cellulose binding domain, glutathione S-transferase, and polyhistidines, and an immobilized ligand. Immobilized metal-affinity chromatography (IMAC) is widely used.

IMAC is based on selective interaction between a solid matrix immobilized with either Cu²⁺ or Ni²⁺ and a polyhistidine tag (His tag). Proteins containing a polyhistidine tag are selectively bound to the matrix while other proteins are removed by washing. See, For example, Stiborova et al., Biotech Bioengineer. 82: 605-611 (2003).

Accordingly, in an exemplary embodiment, the present invention provides an metal polymer having metal chelating properties. The chelating polymer of this invention is a homopolymer, or a copolymer between at least two monomers. The copolymers of the invention optionally include a second subunit in addition to the chelating subunit, which can be used to impart additional functionality to the polymer of the invention. For example, the second subunit can include an energy-absorbing matrix molecule (EAM), a hydrophilic moiety, a UV curable moiety or a combination thereof. The second subunit is either charged or neutral, but preferably is not a metal chelator.

In an exemplary embodiment, the present invention provides a polymer that includes linked monomeric subunits wherein a plurality of the monomeric subunits are chelating subunits. Exemplary chelating subunits have the formula: 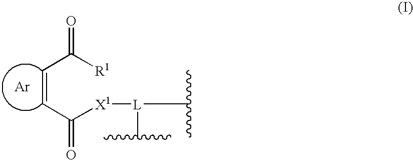
In Formula I, Ar represents substituted or unsubstituted aryl or substituted or unsubstituted heteroaryl. The symbol X¹ represents O or NR², in which R² represents H, substituted or unsubstituted alkyl or substituted or unsubstituted heteroalkyl. R¹ is O⁻, OR³ or NR³R⁴, in which R³ and R⁴ are members independently selected from H, substituted or unsubstituted alkyl and substituted or unsubstituted heteroalkyl.

In Formula I, L is a linker that joins the chelating subunit to another subunit of the polymer. In the homopolymers of the invention, two or more of the chelating subunits are joined through linker, L. Alternatively, in the co-polymers of the invention, the linker can attach a chelating subunit to another chelating subunit or to a non-chelating subunit. Exemplary non-chelating subunits include a moiety such as an energy absorbing moiety, a UV curable moiety, a hydrophilic moiety or a combination thereof.

The linker can be of substantially any useful structure that results from the polymerization reaction used to prepare the homo- or co-polymer of the invention. Exemplary linkers include carbon, substituted or unsubstituted alkyl and substituted or unsubstituted heteroalkyl moieites.

The invention also provides a device that incorporates a chelating polymer of the invention. An exemplary device is a biochip that includes a solid support having a surface.

The chelating polymer is immobilized on the surface of the device by chemisorption or physisorption.

Alternatively, the polymer of the invention can be utilized for chromatographic separation, such as affinity chromatography, ion exchange chromatography and the like. In this embodiment, the substrate is generally formed from a suitable chromatographic material that is suitably configured. Thus, exemplary substrates are in the form of beads or particles.

The substrate typically will have functional groups through which the polymer is immobilized. For example, an aluminum substrate contains surface Al—OH groups. The substrate of a device of the invention can also be coated with silicon dioxide, providing Si—OH groups as loci for attachment. An exemplary substrate is electrically conductive and coated with silicon dioxide, which is further functionalized with an organosilane that includes a reactive functional group, e.g., a polymerizable moiety, e.g., an acryloyl (FIG. 7).

In another aspect, this invention provides a method for detecting an analyte in a sample. The method includes contacting the analyte with a chelating polymer of the invention that captures the analyte. In certain embodiments, the analyte is a biomolecule, such as a polypeptide, a polynucleotide, a carbohydrate, a lipid, or hybrids thereof. In other embodiments, the analyte is an organic molecule such as a drug, drug candidate, cofactor or metabolite. In another embodiment, the analyte is an inorganic molecule, such as a metal complex or cofactor.

Following its capture, the analyte is detected by any of a number art-recognized detection methods. In certain embodiments, the analyte is detected by mass spectrometry, in particular by laser desorption/ionization mass spectrometry. In an exemplary method, when the analyte is a biomolecule, the method includes applying a matrix to the captured analyte before detection. Alternatively, a component of an energy-absorbing matrix is copolymerized into the structure of the chelating polymer. In other embodiments the analyte is labeled, e.g., fluorescently, and is detected on the device by a detector of the label, e.g., a fluorescence detector such as a CCD array. In certain embodiments the method involves profiling a certain class of analytes (e.g., biomolecules) in a sample by applying the sample to one or addressable locations of the device and detecting analytes captured at the addressable location or locations.

Additional aspects and advantages of the invention will be apparent from the detailed description that follows.

### BRIEF DESCRIPTION OF THE DRAWINGS

FIG. 1 is a schematic illustration of the metal chelate affinity capture process.

FIG. 2 is a synthetic scheme for the preparation of an exemplary polymerizable monomer of use to introduce a UV curable moiety into a chelating polymer of the invention.

FIG. 3 is a scheme for the synthesis of a chelating polymer that includes a monomeric subunit with a UV curable moiety and a monomeric subunit with a hydrophilic moiety.

FIG. 4 is a reflectance IR spectrum of a substrate surface onto which was deposited a chelating polymer that includes a monomeric subunit with a UV curable moiety.

FIG. 5 is a composite mass spectrum of albumin depleted human serum acquired using a mass spectrometer probe incorporating a polymer of the invention.

FIG. 6 is a SELDI peak count comparison of albumin depleted human serum profiling of the phthalate surface array with the nitrilotriacetic acid (NTA) surface array.

FIG. 7 is a schematic diagram of a portion of an exemplary surface on which a linker arm, capable of binding to a polymer of the invention, is attached.

FIG. 8 is an exemplary solid support capable of engaging a probe of a mass spectrometer.

### DETAILED DESCRIPTION OF THE INVENTION

I. Abbreviations

EAM (energy absorbing moiety); SPA (Sinapinic acid); CHCA (alpha-cyano-4-hydroxy-succininc acid); CHCAMA, α-cyano-4-methacryloyloxy-cinnamic acid; DHBMA, 2,5-dimethacryloyloxy benzoic acid; DHAPheMA, 2,6-dimethacryloyloxyacetophenone.

II. Definitions

Unless defined otherwise, all technical and scientific terms used herein generally have the same meaning as commonly understood by one of ordinary skill in the art to which this invention belongs. Generally, the nomenclature used herein and the laboratory procedures in cell culture, molecular genetics, organic chemistry, and nucleic acid chemistry and hybridization described below are those well known and commonly employed in the art. Standard techniques are used for nucleic acid and peptide synthesis. The techniques and procedures are generally performed according to conventional methods in the art and various general references, which are provided throughout this document. The nomenclature used herein and the laboratory procedures in analytical chemistry, and organic synthetic described below are those well known and commonly employed in the art. Standard techniques, or modifications thereof, are used for chemical syntheses and chemical analyses.

Where substituent groups are specified by their conventional chemical formulae, written from left to right, they equally encompass the chemically identical substituents which would result from writing the structure from right to left, e.g., —CH₂O— is intended to also recite —OCH₂—; —NHS(O)₂— is also intended to represent. —S(O)₂HN—, etc.

The term “alkyl,” by itself or as part of another substituent, means, unless otherwise stated, a straight or branched chain, or cyclic hydrocarbon radical, or combination thereof, which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to include those derivatives of alkyl defined in more detail below, such as “heteroalkyl.” Alkyl groups, which are limited to hydrocarbon groups are termed “homoalkyl”.

The term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si and S, and wherein the nitrogen and sulfur atoms may optionally be oxidized and the nitrogen heteroatom may optionally be quaternized. The heteroatom(s) O, N and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂,—S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′— represents both —C(O)₂R′— and —R′C(O)₂—.

Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) can be one or more of a variety of groups selected from, but not limited to: —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)₂R′, —S(O)₂NR′R″, —NRSO₂R′, —CN and —NO₂ in a number ranging from zero to (2m′+1), where m′ is the total number of carbon atoms in such radical. R′, R″, R′″ and R″″ each preferably independently refer to hydrogen, substituted or unsubstituted heteroalkyl, substituted or unsubstituted aryl, e.g., aryl substituted with 1-3 halogens, substituted or unsubstituted alkyl, alkoxy or thioalkoxy groups, or arylalkyl groups. When a compound of the invention includes more than one R group, for example, each of the R groups is independently selected as are each R′, R″, R′″ and R″″ groups when more than one of these groups is present. When R′and R″ are attached to the same nitrogen atom, they can be combined with the nitrogen atom to form a 5-, 6-, or 7-membered ring. For example, —NR′R″ is meant to include, but not be limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like).

Each of the above terms is meant to include both substituted and unsubstituted forms of the indicated radical.

As used herein, the term “heteroatom” is meant to include oxygen (O), nitrogen (N), sulfur (S) and silicon (Si).

As used herein, the terms “polymer” and “polymers” include “copolymer” and “copolymers,” and are used interchangeably with the terms “oligomer” and “oligomers.”

“Attached,” as used herein encompasses interactions including chemisorption and physisorption.

“Independently selected” is used herein to indicate that the groups so described can be identical or different.

“Biomolecule” or “bioorganic molecule” refers to an organic molecule typically made by living organisms. This includes, for example, molecules comprising nucleotides, amino acids, sugars, fatty acids, steroids, nucleic acids, polypeptides, peptides, peptide fragments, carbohydrates, lipids, and combinations of these (e.g., glycoproteins, ribonucleoproteins, lipoproteins, or the like).

“Gas phase ion spectrometer” refers to an apparatus that detects gas phase ions. Gas phase ion spectrometers include an ion source that supplies gas phase ions. Gas phase ion spectrometers include, for example, mass spectrometers, ion mobility spectrometers, and total ion current measuring devices. “Gas phase ion spectrometry” refers to the use of a gas phase ion spectrometer to detect gas phase ions.

“Mass spectrometer” refers to a gas phase ion spectrometer that measures a parameter that can be translated into mass-to-charge ratios of gas phase ions. Mass spectrometers generally include an ion source and a mass analyzer. Examples of mass spectrometers are time-of-flight, magnetic sector, quadrupole filter, ion trap, ion cyclotron resonance, electrostatic sector analyzer and hybrids of these. “Mass spectrometry” refers to the use of a mass spectrometer to detect gas phase ions.

“Laser desorption mass spectrometer” refers to a mass spectrometer that uses laser energy as a means to desorb, volatilize, and ionize an analyte.

“Mass analyzer” refers to a sub-assembly of a mass spectrometer that comprises means for measuring a parameter that can be translated into mass-to-charge ratios of gas phase ions. In a time-of-flight mass spectrometer the mass analyzer comprises an ion optic assembly, a flight tube and an ion detector.

“Ion source” refers to a sub-assembly of a gas phase ion spectrometer that provides gas phase ions. In one embodiment, the ion source provides ions through a desorption/ionization process. Such embodiments generally comprise a probe interface that positionally engages a probe in an interrogatable relationship to a source of ionizing energy (e.g., a laser desorption/ionization source) and in concurrent communication at atmospheric or subatmospheric pressure with a detector of a gas phase ion spectrometer.

Forms of ionizing energy for desorbing/ionizing an analyte from a solid phase include, for example: (1) laser energy; (2) fast atoms (used in fast atom bombardment); (3) high energy particles generated via beta decay of radionucleides (used in plasma desorption); and (4) primary ions generating secondary ions (used in secondary ion mass spectrometry). The preferred form of ionizing energy for solid phase analytes is a laser (used in laser desorption/ionization), in particular, nitrogen lasers, Nd-Yag lasers and other pulsed laser sources. “Fluence” refers to the energy delivered per unit area of interrogated image. A high fluence source, such as a laser, will deliver about 1 m^{J/mm}² to about 50 mj / mm². Typically, a sample is placed on the surface of a probe, the probe is engaged with the probe interface and the probe surface is exposed to the ionizing energy. The energy desorbs analyte molecules from the surface into the gas phase and ionizes them.

Other forms of ionizing energy for analytes include, for example: (1) electrons that ionize gas phase neutrals; (2) strong electric field to induce ionization from gas phase, solid phase, or liquid phase neutrals; and (3) a source that applies a combination of ionization particles or electric fields with neutral chemicals to induce chemical ionization of solid phase, gas phase, and liquid phase neutrals.

“Surface-enhanced laser desorption/ionization” or “SELDI” refers to a method of desorption/ionization gas phase ion spectrometry (e.g., mass spectrometry) in which the analyte is captured on the surface of a SELDI probe that engages the probe interface of the gas phase ion spectrometer. In “SELDI MS,” the gas phase ion spectrometer is a mass spectrometer. SELDI technology is described in, e.g., U.S. Pat. No 5,719,060 (Hutchens and Yip) and U.S. Pat. No 6,225,047 (Hutchens and Yip).

“Surface-Enhanced Affinity Capture” (“SEAC”) or “affinity gas phase ion spectrometry” (e.g., “affinity mass spectrometry”) is a version of the SELDI method that uses a probe comprising an absorbent surface (a “SEAC probe”). “Adsorbent surface” refers to a sample presenting surface of a probe to which an adsorbent (also called a “capture reagent” or an “affinity reagent”) is attached. An adsorbent is any material capable of binding an analyte (e.g., a target polypeptide or nucleic acid). “Chromatographic adsorbent” refers to a material typically used in chromatography. “Biospecific adsorbent” refers an adsorbent comprising a biomolecule, e.g., a nucleic acid molecule (e.g., an aptamer), a polypeptide, a polysaccharide, a lipid, a steroid or a conjugate of these (e.g., a glycoprotein, a lipoprotein, a glycolipid, a nucleic acid (e.g., DNA)-protein conjugate). Further examples of adsorbents for use in SELDI can be found in U.S. Pat. No 6,225,047 (Hutchens and Yip, “Use of retentate chromatography to generate difference maps,” May 1, 2001).

In some embodiments, a SEAC probe is provided as a pre-activated surface that can be modified to provide an adsorbent of choice. For example, certain probes are provided with a reactive moiety that is capable of binding a biological molecule through a covalent bond. Epoxide and acyl-imidizole are useful reactive moieties to covalently bind biospecific adsorbents such as antibodies or cellular receptors.

In a preferred embodiment affinity mass spectrometry involves applying a liquid sample comprising an analyte to the adsorbent surface of a SELDI probe. Analytes, such as polypeptides, having affinity for the adsorbent bind to the probe surface. Typically, the surface is then washed to remove unbound molecules, and leaving retained molecules. The extent of analyte retention is a function of the stringency of the wash used. An energy absorbing material (e.g., matrix) is then applied to the adsorbent surface. Retained molecules are then detected by laser desorption/ionization mass spectrometry.

SELDI is useful for protein profiling, in which proteins in a sample are detected using one or several different SELDI surfaces. In turn, protein profiling is useful for difference mapping, in which the protein profiles of different samples are compared to detect differences in protein expression between the samples.

“Surface-Enhanced Neat Desorption” or “SEND” is a version of SELDI that involves the use of probes (“SEND probe”) comprising a layer of energy absorbing molecules attached to the probe surface. Attachment can be, for example, by covalent or non-covalent chemical bonds. Unlike traditional MALDI, the analyte in SEND is not required to be trapped within a crystalline matrix of energy absorbing molecules for desorption/ionization.

SEAC/SEND is a version of SELDI in which both a capture reagent and an energy-absorbing molecule are attached to the sample-presenting surface. SEAC/SEND probes therefore allow the capture of analytes through affinity capture and desorption without the need to apply external matrix. The C18 SEND chip is a version of SEAC/SEND, comprising a C18 moiety which functions as a capture reagent, and a CHCA moiety that functions as an energy-absorbing moiety.

“Surface-Enhanced Photolabile Attachment and Release” or “SEPAR” is a version of SELDI that involves the use of probes having moieties attached to the surface that can covalently bind an analyte, and then release the analyte through breaking a photolabile bond in the moiety after exposure to light, e.g., laser light. SEPAR is further described in U. S. Pat. No 5,719,060.

“Eluant” or “wash solution” refers to an agent, typically a solution, which is used to affect or modify adsorption of an analyte to an adsorbent surface and/or remove unbound materials from the surface. The elution characteristics of an eluant can depend, for example, on pH, ionic strength, hydrophobicity, degree of chaotropism, detergent strength and temperature.

“Monitoring” refers to recording changes in a continuously varying parameter.

III. Embodiments

Introduction

The present invention provides a chelating polymer that can be used to capture and detect analytes. The chelating moieties of these polymers are particularly useful as capture reagents in chips in affinity mass spectrometry, as described above.

The invention also provides a device, such as a biochip, that includes a polymer of the invention attached to its surface. In an exemplary embodiment, the polymer is cured on the surface of a chip to form a biochip. In one embodiment, the surface comprises free hydroxyl groups (e.g., silicon dioxide, aluminium hydroxide or any metal oxides) or amines (e.g., aminosilane) that can react with free reactive moieties, e.g., UV curable moieties, of the chelating polymer. In this way, the polymer can be covalently coupled to the chip surface. Alternatively, the chelating polymer is cured on an inert surface, in which case the polymer becomes physisorbed to the surface. Alternatively, the free OH groups are functionalized with a linker arm that includes a polymerizable moiety that reacts with the polymer, chemi- or physi-sorbing it to the surface.

Moreover, using the polymer of the invention, a device can be constructed readily by synthesizing the polymer in a process that is separate from the process by which the polymer is incorporated into the device, e.g., attached to the substrate of a chip. By separating the attachment of the polymer from the manufacture of the device incorporating the polymer, the individual processes are more readily controlled, varied and tuned. Furthermore, if sufficient polymer is synthesized and it has suitable chemical stability, one can readily synthesize enough material to allow the use of a single lot of polymer over the entire product lifecycle of a given device of the invention. Quite surprisingly, in an embodiment of the methods set forth herein, approximately one million chips of the invention can be prepared from less than one liter of polymer. Thus, using this present method one can produce chips with minimal variability in selectivity over the entire product lifecycle.

The Chelating Polymer

The polymer of the invention includes a plurality of monomeric chelating subunits that include a chelating moiety that can be used to capture one or more analytes, in a sample, to which a metal ion immobilized by the chelating moiety binds. The chelating moieties are analogous to those moieties typically used in chromatography to capture classes of molecules with which they interact and can be selected to have a desired charge at a particular pH value. One of the advantages of the polymers of the invention and surfaces that include these polymers is their utility to chelate a variety of metal ions. Polymers with this property provide access to a wide range of strategies to experimentally control protein adsorption to the polymer.

This invention contemplates chelating polymers that are homo-polymers, co-polymers and blended polymers (that is, linear polymers of a first kind that are mixed with linear polymers of a second kind).

Moreover, the polymer can include energy absorbing moieties that facilitate desorption and ionization of analytes in contact with the polymer, for example in laser desorption/ionization mass spectrometry. The hydrophilicity of the polymer can be tuned by including selected amounts of a hydrophilic subunit in the polymer. Moreover, the polymer can be made UV curable, e.g., cross-linkable, by including a UV curable subunit within the polymer.

In the sections that follow each subunit of the polymer is discussed in greater detail and is exemplified. Selected embodiments of the polymer are exemplified and discussed. Moreover, methods of making devices that include a polymer of the invention, as well as methods of using the polymers and devices to detect an analyte are also set forth.

The Chelating Subunit

In an exemplary aspect, the present invention provides a polymer that includes linked monomeric subunits in which a plurality of the monomeric subunits are chelating subunits. Exemplary chelating subunits have the formula: 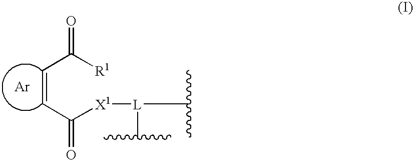
In Formula I, Ar represents substituted or unsubstituted aryl or substituted or unsubstituted heteroaryl. The symbol X¹ represents O or NR², in which R² represents H, substituted or unsubstituted alkyl or substituted or unsubstituted heteroalkyl. R¹ is O⁻, OR³ or NR³R⁴, in which R³ and R⁴ are members independently selected from H, substituted or unsubstituted alkyl and substituted or unsubstituted heteroalkyl.

In Formula I, L is a linker that joins the chelating subunit to another subunit of the polymer. In the homopolymers of the invention, two or more of the chelating subunits are joined through linker, L. Alternatively, in the co-polymers of the invention, the linker can attach a chelating subunit to another chelating subunit or to a non-chelating subunit. Exemplary non-chelating subunits include a moiety such as an energy absorbing moiety, a UV curable moiety, a hydrophilic moiety or a combination thereof.

The linker can be of substantially any useful structure that results from the polymerization reaction used to prepare the homo- or co-polymer of the invention. Exemplary linkers include carbon, substituted or unsubstituted alkyl and substituted or unsubstituted heteroalkyl moieites.

In an exemplary embodiment, the polymer is a cross-linked polymer, e.g., cross-linked using a UV curable moiety that is a component of a monomeric subunit of the polymer. The cross-linked polymer is essentially water-insoluble. In a further exemplary embodiment, the cross-linked polymer is a hydrogel.

Exemplary species for the linker, L, include carbon, substituted or unsubstituted alkyl and substituted or unsubstituted heteroalkyl moieites, including, but not limited to species having the formulae:

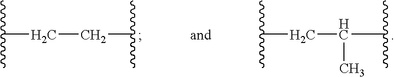

In an exemplary embodiment in which the linker has a structure according to one of the formulae above, the polymer is formed by polymerizing an acrylic or an alkylacrylic, e.g., methylacrylic, monomer. An exemplary methylacrylic monomer of use in forming the polymer of the invention has the formula: 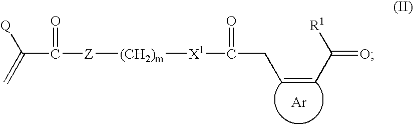
for example,

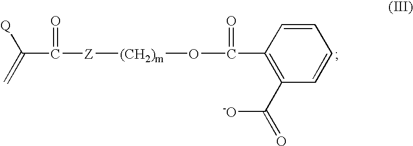

Z is selected from a bond, O, NH and S, and m is an integer from 1 to 10. Q is H or substituted or unsubstituted C₁-C₆ alkyl, e.g., methyl.

Those of skill will appreciate that the formulae above are equally relevant to polymerizable monomers that are based upon an acrylic, rather than a methylacrylic framework.

Hydrophilic Subunit

The hydrophilic subunit functions to enhance the interaction of water with the polymer, particularly the water of an aqueous sample mixture applied to the polymer. An exemplary hydrophilic subunit includes a primary or secondary alcohol, polyol, thiol, polythiol or combinations thereof. Preferably the subunit has two, three or four groups selected from hydroxyls and thiols. Exemplary hydrophilic subunits include alkyl triols, e.g., propyl triols, butyl triols, pentyl triols and hexyl triols. A specific example is trimethylol propane. The hydrophilic subunit is incorporated into the polymer by co-polymerizing a polymerizable monomer that includes the chelating moiety and a polymerizable monomer that includes the hydrophilic moiety. Exemplary polymerizable groups on the hydrophilic polymerizable monomer include, but are not limited to, acrylic, methylacrylic and vinyl moieties.

When the polymer includes only the chelating subunit and a hydrophilic subunit, certain structures for the hydrophilic subunit can be excluded. For example, in these embodiments, it is generally preferred that the hydrophilic subunit is a species formed by the polymerization of a group other than acrylamide and simple unsubstituted alkyl derivatives thereof, e.g., acrylamide, methacrylamide, N-methylacrylamide, N,N-dimethyl(meth)acrylamide, N-isopropy(meth)acrylamide, N-(2-hydroxypropyl)methacrylamide, N-methylolacrylamide. Other groups that generally are excluded from the genus “hydrophilic subunit,” when the polymer includes only a chelating and a hydrophilic subunit, include N-vinylformamide, N-vinylacetamide, N-vinyl-N-methylacetamide, poly(ethylene glycol)(meth)acrylate, poly(ethylene glycol)monomethyl ether mono(meth)acrylate, N-vinyl-2-pyrrolidone, glycerol mono((meth)acrylate), 2-hydroxyethyl(meth)acrylate, vinyl methylsulfone and vinyl acetate. Any of the above-enumerated excluded subunits can be utilized when the polymer includes a third subunit, e.g., EAM subunit, UV curable subunit, in addition to the chelating and hydrophilic subunit. Moreover, any of the excluded subunits are optionally used when the polymer is incorporated into a device, such as a biochip, or when the polymer is used to practice a method of the invention.

An exemplary hydrophilic subunit of use in the polymers of the invention has the formula: 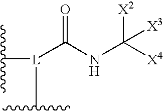
in which X², X³ and X⁴ represent groups that are independently selected from H, OH, substituted or unsubstituted alkyl, or substituted or unsubstituted heteroalkyl unsubstituted alkyl. In an exemplary embodiment, one of X², X³ or X⁴ is alkyl substituted with one or more OR⁴, in which R⁴ is H, or C₁-C₄ alkyl. L is a linker that joins the hydrophilic subunit to another subunit of the polymer. In selected hydrophilic subunits of use in polymers the invention, at least two of X², X³ and X⁴ are independently selected from OH, heteroalkyl and alkyl substituted with one or more OR⁴. In an exemplary embodiment, each of X², X³ and X⁴ is CH₂OH.

A further exemplary hydrophilic subunit includes a moiety that is a diol, or an ether, for example, an alkylene glycol, a poly(alkylene glycol), or an alkyl, aryl, heteroaryl or heterocycloalkyl diol. When the hydrophilic moiety is a poly(alkylene glycol), such as polyethylene glycol or polypropylene glycol, it preferably has a molecular weight from about 200 to about 20,000, more preferably from about 200 to about 4000.

In an exemplary embodiment, the hydrophilic subunit is selected so that the polymer containing this subunit is more hydrophilic than an identical polymer without the hydrophilic subunit.

Exemplary polymerizable hydrophilic monomers of use in preparing the polymers of the invention have the formula: 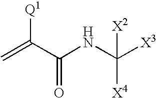
in which the X², X³ and X⁴ represent the groups discussed above, and Q¹ is H, or substituted or unsubstituted C₁-C₆ alkyl, e.g., methyl.

An exemplary hydrophilic polymerizable monomer of use in the invention has the formula: 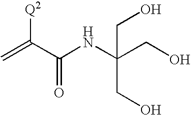
Q² is H, or substituted or unsubstituted C₁-C₆ alkyl, e.g., methyl.
The EAM Subunit

Exemplary chelating polymers of the invention are functionalized with one or more energy absorbing subunit that includes a component conveniently designated as an energy absorbing molecule (EAM) moiety. Generally, these functionalities are incorporated into the chelating polymer through a polymerizable monomer that includes the desired EAM moiety and a polymerizable moiety, e.g., acrylate, methacrylate, vinyl, etc.

EAM subunits in the chelating polymer are useful for promoting desorption and ionization of analyte into the gas phase during laser desorption/ionization processes. The EAM subunit comprises a photo-reactive moiety. The photo-reactive moiety includes a group that absorbs photo-radiation from a source, e.g., a laser, converts it to thermal energy and transfers the thermal energy to the analyte, promoting its desorption and ionization from the chelating polymer.

In the case of UV laser desorption, exemplary EAM subunits include an aryl nucleus that absorbs photo-irradiation, e.g., UV or IR. Exemplary UV photo-reactive moieties include benzoic acid (e.g., 2,5 di-hydroxybenzoic acid), cinnamic acid (e.g., α-cyano-4-hydroxycinnamic acid), acetophenone, quinone, vanillic acid (isovanillin), caffeic acid, nicotinic acid, sinapinic acid, pyridine, ferrulic acid, 3-amino-quinoline and derivatives thereof. An IR photo-reacitve moiety can be selected from benzoic acid (e.g., 2,5 di-hydroxybenzoic acid, 2-aminobenzoic acid), cinnamic acid (e.g., α-cyano-4-hydroxycinnamic acid), acetophenone (e.g. 2,4,6-trihyroxyacetophenone and 2,6-dihyroxyacetophenone), trans-3-indoleacrylic acid, caffeic acid, ferrulic acid, sinapinic acid, 3-amino-quinoline, picolinic acid, nicotinic acid, acetamide, salicylamide and derivatives thereof. In the case of IR laser desorption, exemplary EAM subunits include an aryl nucleus or a group that absorbs the IR radiation through direct vibrational resonance or in slight off-resonance fashion. Representative polymerizable EAM monomers of use in preparing the polymers of the invention are described in Kitagawa et al., published U.S. patent application Ser. No. 2003/0207462.

By way of exemplification, an EAM that is of use in forming the polymers of the invention includes the structure: 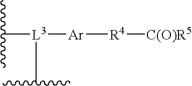
in which Ar is substituted or unsubstituted aryl or substituted or unsubstituted heteroaryl. Exemplary Ar groups include Ar substituted or unsubstituted phenyl, substituted or unsubstituted indolyl and substituted or unsubstituted pyridyl. The symbol R⁴ represents a bond, substituted or unsubstituted alkyl or substituted or unsubstituted heteroalkyl. R⁵ is a member selected from H, OH and substituted or unsubstituted alkyl. L³ is a linker that is a bond, substituted or unsubstituted alkyl or substituted or unsubstituted heteroalkyl. The linker includes a bond to a subunit of the polymer, such as a non-chelating subunit that includes a hydrophilic moiety, another non-chelating subunit that includes an energy absorbing moiety or a chelating subunit that is a member of the plurality of chelating subunits in the polymer.

In selected embodiments, R⁴ has the formula: [symbol] —CR¹¹=CR¹²— [symbol]
in which R¹¹ and R¹² are members independently selected from H, substituted or unsubstituted alkyl, substituted or unsubstituted heteroalkyl, and CN. Exemplary moieties according to this formula include:

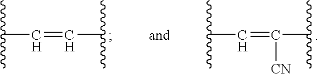

Exemplary EAM subunits include an aryl moiety having a formula that is selected from the group including: 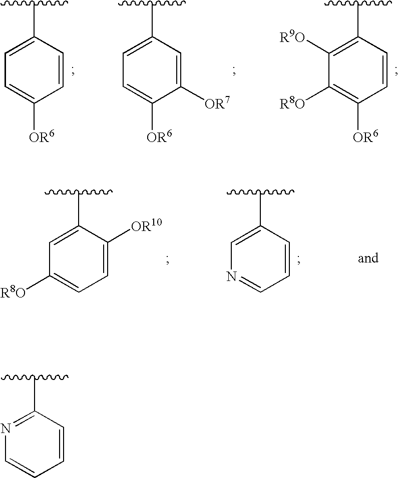
in which R⁶, R⁷, R⁸, R⁹ and R¹⁰ are members independently selected from H and substituted or unsubstituted alkyl. Exemplary moieties for R⁶, R⁷, R⁸, R⁹ and R¹⁰ include groups independently selected from H and C₁-C₆ unsubstituted alkyl.

Exemplary EAM subunits in the polymer of the invention have the formulae: 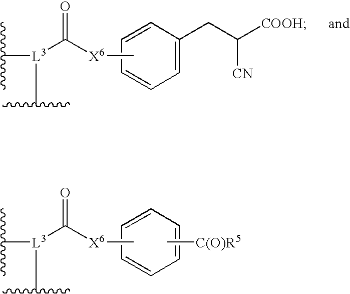
in which the symbol X⁶ is O, S or NH. R⁵ is H, NR⁶R⁷, OR⁶, SR⁶, substituted or unsubstituted alkyl, substituted or unsubstituted heteroalkyl and substituted or unsubstituted aryl. The symbols R⁶ and R⁷ independently represent H, substituted or unsubstituted alkyl, substituted or unsubstituted heteroalkyl and substituted or unsubstituted aryl.

Exemplary polymerizable EAM monomers of use in preparing the polymers of the invention have the formulae: 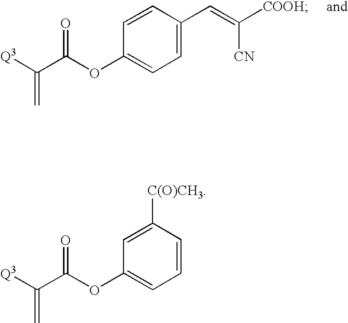
Q³ is H, or substituted or unsubstituted C₁-C₆ alkyl, e.g., methyl.
Photo-Polymerizable Subunit (UV Curable Subunit)

Exemplary chelating polymers of the invention are functionalized with one or more group conveniently designated as a photopolymerizable, or UV curable, moiety. Generally, these finctionalities are incorporated into the chelating polymer through a polymerizable monomer that includes the desired UV curable moiety and a polymerizable moiety, e.g., acrylate, methacrylate, vinyl, etc.

The photo-polymerizable moiety is of use to form cross-links within the bulk polymer itself, to cross-link the polymer to a polymerizable moiety on the surface of a device, e.g., an acrylic- or methylacrylic-functionalized linker arm attached to the surface of the device, or a combination of thereof. A large number of photo-polymerizable moieties are known in the art. The discussion that follows exemplifies this component of polymers of the invention by reference to the benzophenone group, however, those of skill understand that it is equally relevant to other UV curable groups, e.g., a diazoester, an arylazide and a diazirine.

In an exemplary embodiment, the chelating polymer of the invention includes a photopolymerizable moiety having the general formula: 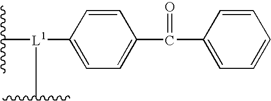
in which L¹ is a linker that is a bond, substituted or unsubstituted alkyl and substituted or unsubstituted heteroalkyl. The linker includes a bond to another subunit of the polymer, such as a non-chelating subunit that includes a hydrophilic moiety, a non-chelating subunit that includes an energy absorbing moiety and a chelating subunit that is a member of the plurality of chelating subunits in the polymer.

In a further exemplary embodiment, the linker, L¹, includes the structure: [symbol]
—NH(CH₂)ₜNHC(O)— [symbol]
in which t is an integer from 1 to 10.

An exemplary photopolymerizable monomer that is of use to incorporate a UV curable subunit into the polymers of the invention has the formula: 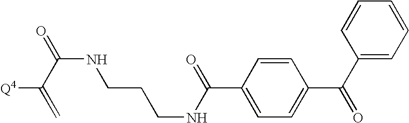
in which Q⁴ is H or substituted or unsubstituted C₁-C₆ alkyl, e.g., methyl.
Polymer Formats

In the present section, selected polymer formats are set forth to exemplify the chelating polymers of the invention. The focus of the discussion on these exemplary polymer formats is for clarity of illustration and should not be interpreted as limiting the scope of the invention to the specific formats. Other combinations of the basic subunits discussed above will be apparent to those of skill in the art.

In an exemplary embodiment, the invention provides a polymer that includes a polymeric unit that has the formula: 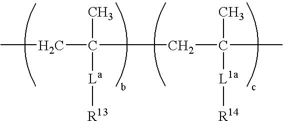
in which L^{a} and L^{1a} are linkers independently selected from a bond, substituted or unsubstituted alkyl and substituted or unsubstituted heteroalkyl moieties. An exemplary linker, L^{a}, has the formula —C(O)-Z-(CH₂)ₘ—, in which the identities of Z and m are as discussed above.

The subunit having the formula: 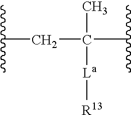
is the chelating subunit, and R¹³ is a chelating moiety having the formula: 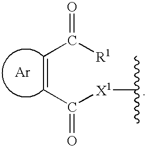
The identities of X¹, and R¹ and the index n are as discussed above.

The subunit having the formula: 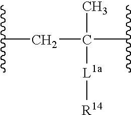
is a subunit other than the chelating subunit, for example, a non-chelating subunit that includes a hydrophilic moiety, a non-chelating subunit that includes a UV curable moiety or a non-chelating subunit that includes an energy absorbing moiety. The symbol R¹⁴ represents the hydrophilic moiety, the UV curable moiety or the energy absorbing moiety. The indices b and c are independently selected numbers from 0.01 to 0.99, such that (b+c) is 1.

An exemplary polymeric unit according to the formula above has the formula: 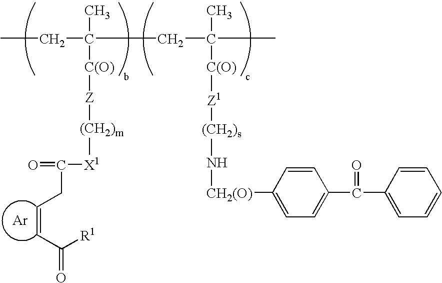
in which Z and Z¹ are members independently selected from a bond, O, NH and S. R¹ is as discussed above; and the indices m, and s are independently selected from the integers from 1 to 10.

A further exemplary polymeric unit has the formula: 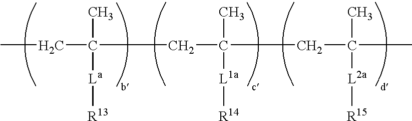
in which L^{a}, L^{1a} and L^{2a} are linkers independently selected from a bond, substituted or unsubstituted alkyl and substituted or unsubstituted heteroalkyl moieties. An exemplary linker, L^{a}, has the formula —C(O)-Z-(CH₂)ₘ—, in which the identities of Z and m are as discussed above.

The subunit having the formula: 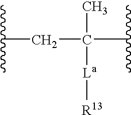
is the chelating subunit, and R¹³ is a chelating moiety according to Formula I.

The subunits having the formulae: 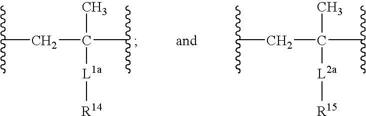
are independently selected from subunits other than the chelating subunit, e.g., the non-chelating subunit that includes a hydrophilic moiety, the non-chelating subunit that includes a UV curable moiety and the non-chelating subunit that includes an energy absorbing moiety. The symbols R¹⁴ and R¹⁵ independently represent the hydrophilic moiety, the UV curable moiety or the energy absorbing moiety. The indices b′, c′ and d′ are independently selected numbers from 0.01 to 0.99, such that (b′+c′+d′)=1.

An exemplary polymer according to the format set forth immediately above, includes the polymeric unit: 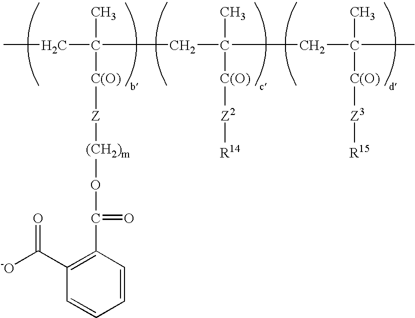
in which the symbols Z, Z² and Z³ independently represent a bond, O, S or NH. The indices m, n and s are integers independently selected from 1 to 10. The indices b′, c′ and ′ are independently selected numbers from 0.01 to 0.99, such that (b +c +d)=1.

As those of skill will appreciate, the methyl group of any of the methacryloyl moieties in the formulae set forth above can be replaced by H, or substituted or unsubstituted C₁-C₆ alkyl.

Exemplary hydrophilic and UV curable moieties represented by the symbols R¹⁴ and R¹⁵ include:

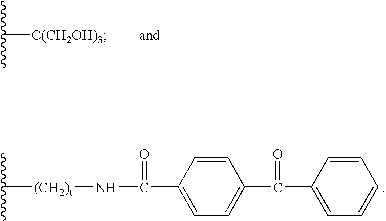

As will be readily understood by those of skill in the art, though the polymers of the invention are exemplified hereinabove by reference to polymers that are formed from methacrylamide monomers, the structures set forth above also describe embodiments in which one or more of the monomers is an acrylamide monomer of an alkyl acrylamide monomer (e.g., substituted with substituted or unsubstituted C₁-C₆ alkyl other than methyl).

Use of the term “polymeric unit” is based on the recognition that, although the polymerization process is essentially random, the polymers of the invention include at least one polymer unit within the bulk polymer structure that corresponds to the disclosed formula. The polymeric unit is not intended to define the bulk structure of the polymer nor to imply that the entire polymer has the formula of the disclosed polymeric unit.

In another embodiment, chelating polymer is polysaccharide based. For example, polysaccharides provided with polymerizable moieties, such as vinyl groups, can be co-polymerized with a chelating monomer of this invention, such as those of formulae II, III or IV. (See, e.g., US 2003/0218130 A1 (Boschetti et al.), incorporated herein by reference. An exemplary polymer according to this embodiment includes a saccharide, e.g., a soluble, nonionic polysaccharide, derivatized with a second polymerizable moiety at one or more of the saccharyl hydroxyl groups. The polysaccharides are optionally cross-linked to each other through bonds resulting from a polymerization reaction between the polymerizable moieties. Exemplary polysaccharides include alginate, dextran, starch, hydroxyethyl starch, cellulose, carboxymethyl cellulose, etc. Exemplary cross-linking agents include N,N′-methylene-bis-acrylamide, N,N′-methylene-bis-methacrylamide, poly(ethylene glycol) dimethacrylate and diallyltartardiamide.

In another embodiment, the chelating polymer is polyurethane based. For example, the chelating monomer can include a hydroxyl moiety. This monomer is polymerized with monomers having at least two isocyanate units into a polyurethane that includes pendant chelating groups. (See, e.g., U.S. patent application Ser. No. 10/965,092, filed Oct. 14, 2004 (Chang et al.), incorporated herein by reference. The resulting polymer is readily functionalized with an array of different functional groups and binding functionalities to provide a chelating polymer having a selected property, e.g., affinity for a particular analyte or class of analytes.

Preparation of Chelating Polymers

In an exemplary method of preparing the polymers of the invention, one or more of the monomers above are assembled into a chelating polymer of this invention. The monomers are combined in selected proportions and subjected to polymerization reaction conditions so that bulk polymer has a pre-selected proportion of the various subunits described above. The polymer prepared according to this method can be prepared in bulk, and later distributed onto a device of the invention. Alternatively, for example when the polymer is used in conjunction with a biochip, the monomers can be deposited on a pre- selected region of the chip and polymerized in situ.

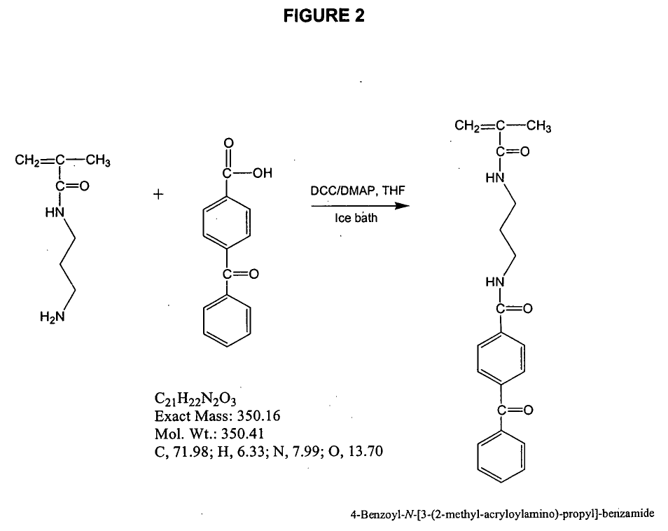

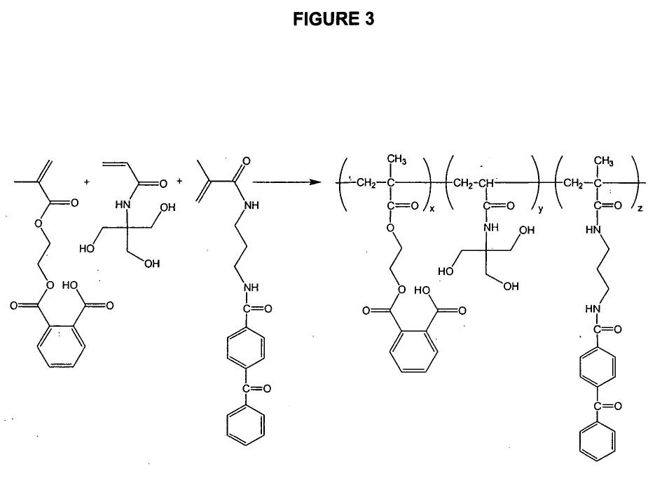

For example, an exemplary chelating, UV curable polymer is prepared as shown in Scheme 1 (FIG. 3). In Scheme 1, a polymerizable chelating moiety, a polymerizable hydrophilic monomer and a polymerizable UV curable moiety are combined with an initiator. Thus, a polymerizable chelating monomer, including a methylacrylic moiety is combined with a methacryloyl polymerizable monomer having a UV curable moiety in the presence of an initiator, thereby producing a polymer that includes both a chelating subunit and a UV curable subunit. The polymerizable UV curable monomer is prepared as set forth in Scheme 2 (FIG. 2).

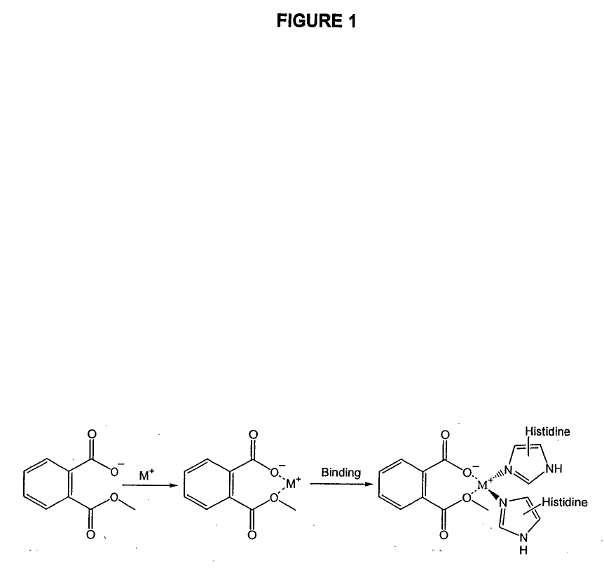

Prior to its use to bind an analyte, the chelating polymer is optionally chelated with a metal ion, e.g., copper, nickel, etc. (FIG. 1).

In another exemplary method, a polymer backbone that includes one or more reactive functional group is prepared and subsequently derivatized with the chelating moiety by coupling the reactive polymer backbone with a chelating moiety of complementary reactivity. An exemplary reactive polymer of use in this method is the polyurethane polymer that is described in co-pending, commonly owned U.S. patent application Ser. No. 10/965,092. The reactive polymer can be functionalized with the chelating moiety either in bulk or, alternatively, the reactive polymer can be deposited onto a surface and subsequently functionalized with the chelating moiety.

The Devices

The devices of this invention comprise a solid support having a surface and a polymer of the invention attached to the surface through physi- or chemi-sorption. The devices can be in the form of chips or plates, chromatographic sorbents or membranes, depending upon the nature of the solid substrate and the intended use. The following section is generally applicable to each device of the invention. In selected devices of the invention the polymer is immobilized on a substrate, either directly or through linker arm arms that are interposed between the substrate and the polymer. The nature and intended use of the device influences the configuration of the substrate. For example, a chip or plate of the invention is typically based upon a planar substrate format. A chromatographic support of the invention can be, for example, a monolith, a fiber, or particles (both irregular and spherical, and typically between 5 microns and 200 microns in diameter). A microtiter plate is generally formed from a plastic (e.g., polypropylene), and it includes multiple wells for holding liquid. Common formats for microtiter plates include 48 well, 96 well and 384 well configurations. A membrane of the invention is formed using a porous substrate.

The following section details five exemplary methods for making a device of this invention in which a chelating polymer is attached to a solid substrate. In a first embodiment, chelating monomers are polymerized or co-polymerized with other monomers upon the surface of the substrate, and attached non-covalently. For example, a chelating monomer comprising an acrylate or methacrylate group is polymerized with or without a cross-linking moiety on the surface of a substrate. The resulting polymer may be physisorbed to the surface or chemisorbed, depending on the nature of the surface.

In a second embodiment, a chelating polymer or blended polymer is applied to the substrate surface and becomes attached non-covalently.

In a third embodiment, chelating monomers are polymerized or co-polymerized with other monomers on a surface comprising moieties to which the polymer can be attached covalently. For example, a chelating monomer comprising an acrylate or methacrylate group is polymerized with or without a cross-linking moiety on the surface of a substrate that, itself, comprises polymerizable moieties, such as vinyl or acrylate groups. In another embodiment, the polymer is a co-polymer of chelating monomers and benzophenone monomers, and the surface comprises groups with which the benzophenone can couple upon curing. The monomers are both polymerized and cured on the surface.

In a fourth embodiment, a chelating polymer, co-polymer or blended polymer is covalently attached to a surface through a reactive moiety. For example, a chelating polymer is applied to a surface that already has a polymer with benzophenone groups on it. Upon curing, a blended polymer results, whereby the chelating polymer is attached to the polymer already on the surface.

In a fourth embodiment, a chelating moiety can be covalently incorporated into polymer backbone by modifying a pre formed polymer. For instance, the hydroxyl groups of dextran or other polysaccharides can be derivatized with a chelating moiety to form a chelating polymer. The derivatization reaction can be done in bulk or on the chip surface, e.g., a polysaccharide can be first immobilized on the surface, and then the polysaccharide-coated surface is derivatized with a chelating moiety through an appropriate reaction.

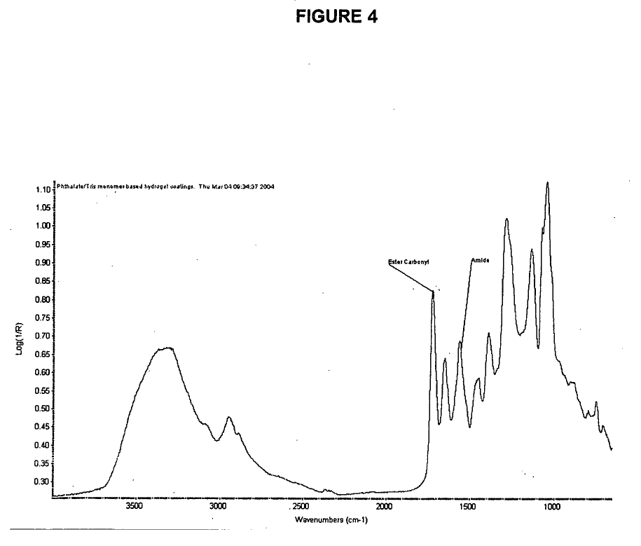

In an exemplary device of the invention, the polymer is cross-linked and immobilized on the device surface by coating the surface with uncured polymer and submitting the coated substrate to treatment with UV radiation. When the UV curable moiety is benzophenone, curing can be accomplished by irradiating the material for between about 1 minutes and about 5 hours with light of a wavelength of from about 300 nm to 400 nm. The presence of the polymer is readily verified by analytical techniques such as reflectance IR spectroscopy; this method is utilized to verify the presence of the polymers of the invention (FIG. 3) on a substrate surface (FIG. 4).

An exemplary method of making the devices of this invention involves polymerizing the chelating monomeric subunits, either alone or with another of the described monomeric subunits, and curing the polymer on the surface of the solid support. More particularly, when the polymer includes a UV curable subunit, curing causes a reaction between the UV curable moiety of the polymer and a reactive functionality on the surface of the substrate, e.g. abstractable hydrogen sources. The reaction results in the formation of a covalent bond that couples the polymer to the substrate. Additionally, the UV curing step forms cross-links within the bulk polymer, forming a cross-linked chelating polymer.

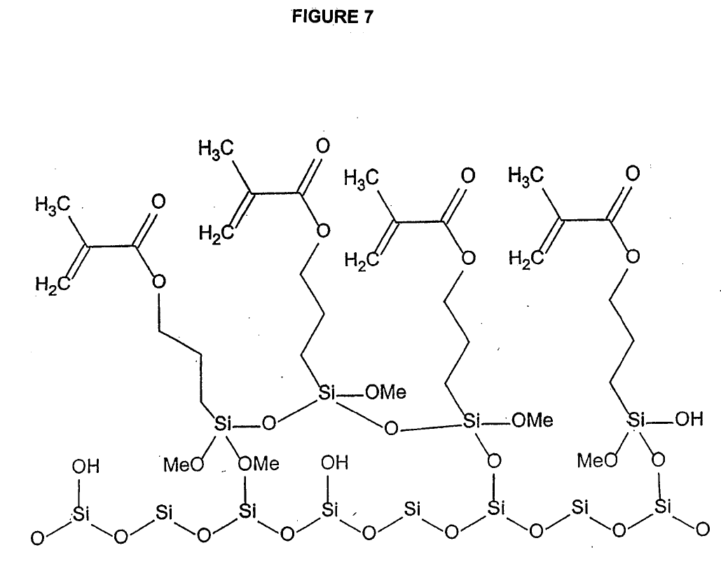

In an exemplary embodiment, the solid support is derivatized with a reactive moiety, e.g. a methylacryl moiety, prior to contacting the surface with the polymer and curing the polymer on the device. An exemplary species of use for modifying the device surface, and a generalized diagram of such a surface is shown in FIG. 7.

When the solid support is a chip, the chelating polymer is applied to the surface by any useful method, e.g., spotting (to discrete locations), spin coating (to cover the entire surface) or dipping. The thickness of the gel depends on the intended use of the gel. For surface scanning techniques, such as surface plasmon resonance or diffraction grating coupled optical waveguide biosensors, the gel is preferably between about 50 nm and about 200 nm. For methods such as SELDI mass spectrometry, the thickness is preferably from about 50 nm to about 10 microns.

Chips

This invention includes devices in which the surface of a substrate in the form of a chip is coated with the chelating polymer of the invention. In the section that follows, the invention is exemplified by reference to a biochip prepared using a polymeric composition of the method. The focus of the discussion is for clarity of illustration. Those of skill will appreciate that chip formats other than a biochip are usefully practiced with the chelating polymers of the invention.

Substrate

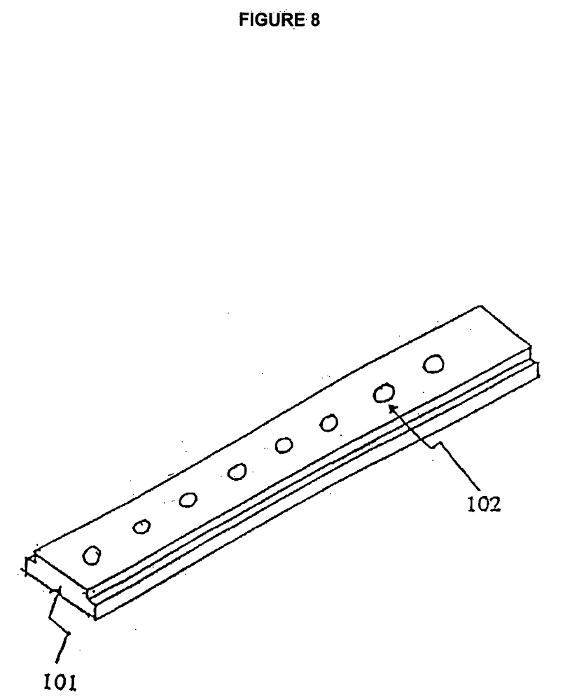

In chips of the invention, the polymer is immobilized on a substrate, either directly or through linker arms that are interposed between the substrate and the polymer (FIG. 8). Exemplary chips of the invention are formed using a planar substrate, which is optionally patterned.

Substrates that are useful in practicing the present invention can be made of any stable material, or combination of materials. Moreover, the substrates can be configured to have any convenient geometry or combination of structural features. The substrates can be either rigid or flexible and can be either optically transparent or optically opaque. The substrates can also be electrical insulators, conductors or semiconductors. When the sample to be applied to the chip is water based, the substrate preferable is water insoluble.

In an exemplary embodiment, the substrate includes an aluminum support that is coated with a layer of silicon dioxide. The silicon dioxide layer is optionally from about 1000-3000 Å in thickness, and can be functionalized with a linker arm of one or more structure; a typical linker arm includes a polymerizable moiety that reacts with a complementary moiety on the polymer. In other embodiments, the substrate is formed from or includes a polymeric material, such as cellulose or a plastic.

The surface of a substrate of use in practicing the present invention can be smooth, rough and/or patterned. The surface can be engineered by the use of mechanical and/or chemical techniques. For example, the surface can be roughened or patterned by rubbing, etching, grooving, stretching, and the oblique deposition of metal films. The substrate can be patterned using techniques such as photolithography (Kleinfield et al., J Neurosci. 8: 4098-120 (1998)), photoetching, chemical etching and microcontact printing (Kumar et al., Langmuir 10: 1498-511 (1994)). Other techniques for forming patterns on a substrate will be readily apparent to those of skill in the art.

The size and complexity of the pattern on the substrate is controlled by the resolution of the technique utilized and the purpose for which the pattern is intended. For example, using microcontact printing, features as small as 200 nm have been layered onto a substrate. See, Xia et al., J Am. Chem. Soc. 117: 3274-75 (1995). Similarly, using photolithography, patterns with features as small as 1 μm have been produced. See, Hickman et al., J Vac. Sci. Technol. 12: 607-16 (1994). Patterns that are useful in the present invention include those which comprise features such as wells, enclosures, partitions, recesses, inlets, outlets, channels, troughs, diffraction gratings and the like.

In an exemplary embodiment, the patterning is used to produce a substrate having a plurality of adjacent addressable features, wherein each of the features is separately identifiable by a detection means. In another exemplary embodiment, an addressable feature does not fluidically communicate with other adjacent features. Thus, an analyte, or other substance, placed in a particular feature remains essentially confined to that feature. In another preferred embodiment, the patterning allows the creation of channels through the device whereby fluids can enter and/or exit the device.

Using recognized techniques, substrates with patterns having regions of different chemical characteristics can be produced. Thus, for example, an array of adjacent, isolated features is created by varying the hydrophobicity/hydrophilicity, charge or other chemical characteristic of a pattern constituent. For example, hydrophilic compounds can be confined to individual hydrophilic features by patterning “walls” between the adjacent features using hydrophobic materials. Similarly, positively or negatively charged compounds can be confined to features having “walls” made of compounds with charges similar to those of the confined compounds. Similar substrate configurations are also accessible through microprinting a layer with the desired characteristics directly onto the substrate. See, Mrkish,et al., Ann. Rev. Biophys. Biomol. Struct. 25:55-78 (1996).

The specificity and multiplexing capacity of the chips of the invention is improved by incorporating spatial encoding (e.g., addressable locations, spotted microarrays) into the chip substrate. Spatial encoding can be introduced into each of the chips of the invention. In an exemplary embodiment, binding finctionalities for different analytes can be arrayed across the chip surface, allowing specific data codes (e.g., target-binding functionality specificity) to be reused in each location. In this case, the array location is an additional encoding parameter, allowing the detection of a virtually unlimited number of different analytes.

In the embodiments of the invention in which spatial encoding is utilized, they preferably utilize a spatially encoded array comprising m regions of chelating polymer distributed over m regions of the substrate. Each of the m regions can be a different chelating polymer or the same chelating polymer, or different chelating polymers can be arranged in patterns on the surface. For example, in the case of matrix array of addressable locations, all the locations in a single row or column can have the same chelating polymer. The m binding finctionalities are preferably patterned on the substrate in a manner that allows the identity of each of the m locations to be ascertained. In another embodiment, the m chelating polymers are ordered in a p by q matrix (p×q) of discrete locations, wherein each of the (p×q) locations has bound thereto at least one of the m chelating polymer. The microarray can be patterned from essentially any type of chelating polymer of the invention.

Mass Spectrometer Probe

In an exemplary embodiment, the chip of this invention is designed in the form of a probe for a gas phase ion spectrometer, such as a mass spectrometer probe. To facilitate its being positioned in a sample chamber of a mass spectrometer, the substrate of the chip is generally configured to include means that engage a complementary structure within the probe interface. The term “positioned” is generally understood to mean that the chip can be moved into a position within the sample chamber in which it resides in appropriate alignment with the energy source for the duration of a particular desorption/ionization cycle. There are many commercially available laser desorption/ionization mass spectrometers. Vendors include Ciphergen Biosystems, Inc., Waters, Micromass, MDS, Shimadzu, Applied Biosystems and Bruker Biosciences.

An exemplary structure according to this description is a chip that includes means for slidably engaging a groove in an interface, such as that used in the Ciphergen probes (FIG. 8). In this figure, the means to position the probe in the sample chamber is integral to substrate 101, which includes a lip 102 that engages a complementary receiving structure in the probe.

In another example, the probe is round and is typically attached to a holder/actuator using a magnetic coupler. The target is then pushed into a repeller and makes intimate contact to insure positional and electrical certainty.

Other probes are rectangular and they either marry directly to a carrier using a magnetic coupling or physically attach to a secondary carrier using pins or latches. The secondary carrier then magnetically couples to a sample actuator. This approach is generally used by systems which have autoloader capability and the actuator is generally a classical x, y 2-d stage.

In yet another exemplary embodiment, the probe is a barrel. The barrel supports a polymer, hydrogel or other species that binds to an analyte. By rotating and moving in the vertical plane, a 2-d stage is created.

Still a further exemplary embodiment the probe is a disk. The disk is rotated and moved in either a vertical or horizontal position to create an r-theta stage. Such disks are typically engaged using either magnetic or compression couplers.

Chromatographic Supports

In an exemplary embodiment, the chelating polymer of the invention is used to form a chromatographic support. A layer of the chelating polymer is used to coat a particulate substrate. Particulate substrates that are useful in practicing the present invention can be made of practically any physicochemically stable material. Useful particulate substrates are not limited to a size or range of sizes. The choice of an appropriate particle size for a given application will be apparent to those of skill in the art.

The particles of the invention can also be used as a solid support for a variety of syntheses. The particles are useful supports for synthesis of small organic molecules, polymers, nucleic acids, peptides and the like. See, for example, Kaldor et al., “Synthetic Organic Chemistry on Solid Support,” In, COMBINATORIAL CHEMISTRY AND MOLECULAR DIVERSITY IN DRUG DISCOVERY, Gordon et al., Eds., Wiley-Liss, New York, 1998.

Membranes

In an exemplary embodiment, the polymer of the invention is used to form a membrane. For example, a layer of the polymer is used to coat a porous substrate. Alternatively, the membrane is formed from the polymer itself. The membranes of the invention are optionally formed by methods known in the art. See, for example, Mizutani, Y. et al., J AppL. Polym. Sci. 1990, 39, 1087-1100), Breitbach, L. et al., Angew. Makromol. Chem. 1991, 184, 183-196 and Bryjak, M. et al., Angew. Makromol. Chem. 1992, 200, 93-108).

Micro-, Nano-titer Plates

In another exemplary embodiment, the polymer of the invention is used in a device that is in a multi-welled device format, e.g., micro- or nano-titer plate. For example, a layer of the polymer can be used to coat the interior of the wells of the multi-welled substrate. Alternatively, the inner surface of the wells of the nano- or micro-titer plates are formed from the polymer itself. Popular formats for micro- and nano-titer plates include 48-, 96- and 384-well configurations. In an exemplary embodiment, the plate is made of a polymer, e.g., polypropylene.

Methods of Using the Devices

The devices of the present invention are useful for the isolation and detection of analytes. In particular, polymers and devices of the invention are useful in performing assays of substantially any format including, but not limited to chromatographic capture, immunoassays, competitive assays, DNA or RNA binding assays, fluorescence in situ hybridization (FISH), protein and nucleic acid profiling assays, sandwich assays, laser desorption mass spectrometry and the like.

In general, the methods involve applying a sample comprising an analyte to the chelating polymer which is attached to a solid support. The chelating moiety binds to analytes that preferentially bind zwitterions. An appropriate buffer for such a binding reaction could be, e.g., sodium phosphate. Then, unbound material is washed off using a wash solution of a stringency selected by the investigator. This leaves the captured analyted retained on the device through interaction with the chelating moiety. The captured analyte is then detected by means appropriate for the device and deemed desirable by the investigator. For example, in laser desorption mass spectrometry, a matrix, such as SPA, can be applied to the chip to facilitate desorption/ionization of intact analytes.

Detection

The chips of this invention are useful for the detection of analyte molecules. The chelating moiety of the polymer acts as a capture reagent; the polymer will capture analytes that interact with the chelating moiety. Unbound materials can be washed off, and the analyte can be detected in any number of ways including, for example, a gas phase ion spectrometry method, an optical method, an electrochemical method, atomic force microscopy and a radio frequency method. Gas phase ion spectrometry methods are described herein. Of particular interest is the use of mass spectrometry and, in particular, SELDI. Optical methods include, for example, detection of fluorescence, luminescence, chemiluminescence, absorbance, reflectance, transmittance, birefringence or refractive index (e.g., surface plasmon resonance, ellipsometry, quartz crystal microbalance, a resonant mirror method, a grating coupler waveguide method (e.g., wavelength-interrogated optical sensor (“WIOS”) or interferometry). Optical methods include microscopy (both confocal and non-confocal), imaging methods and non-imaging methods. Immunoassays in various formats (e.g., ELISA) are popular methods for detection of analytes captured on a solid phase. Electrochemical methods include voltametry and amperometry methods. Radio frequency methods include multipolar resonance spectroscopy or interferometry. Optical methods include microscopy (both confocal and non-confocal), imaging methods and non-imaging methods. Immunoassays in various formats (e.g., ELISA) are popular methods for detection of analytes captured on a solid phase. Electrochemical methods include voltametry and amperometry methods. Radio frequency methods include multipolar resonance spectroscopy.

In an exemplary embodiment, the polymer is patterned on a chip at a plurality of addressable locations, and detection of one or more molecular recognition events, at one or more locations within the addressable locations, does not require removal or consumption of more than a small fraction of the total chelating-analyte complex. Thus, the unused portion can be interrogated further after one or more “secondary processing” events conducted directly in situ (i.e., within the boundary of the addressable location) for the purpose of structure and function elucidation, including further assembly or disassembly, modification, or amplification (directly or indirectly).

Mass Spectroscopy/SEND

Desorption detectors comprise means for desorbing the analyte from the capture reagent (e.g., chelating polymer) and means for detecting the desorbed analyte. The desorption detector detects desorbed analyte without an intermediate step of capturing the analyte in another solid phase and subjecting it to subsequent analysis. Detection of an analyte normally includes detection of signal strength. This, in turn, reflects the quantity of analyte adsorbed to the adsorbent.

The desorption detector also can include other elements, e.g., a means to accelerate the desorbed analyte toward the detector, and a means for determining the time-of-flight of the analyte from desorption to detection by the detector.

A preferred desorption detector is a laser desorption/ionization mass spectrometer, which is well known in the art. The mass spectrometer includes a port into which the substrate that carries the adsorbed analytes, e.g., a probe, is inserted. Striking the analyte with energy, such as laser energy desorbs the analyte. Radiation from the laser impinging on the adsorbed analyte results in desorption of the intact analyte into the flight tube and its ionization. The flight tube generally defines a vacuum space. Electrified plates in a portion of the vacuum tube create an electrical potential which accelerate the ionized analyte toward the detector. A clock measures the time of flight and the system electronics determines velocity of the analyte and converts this to mass. As any person skilled in the art understands, any of these elements can be combined with other elements described herein in the assembly of desorption detectors that employ various means of desorption, acceleration, detection, measurement of time, etc. An exemplary detector further includes a means for translating the surface so that any spot on the array is brought into line with the laser beam.

When the method of detection involves a laser desorption/ionization process, chelating hydrogels of this invention that are functionalized with EAMs, are particularly useful. The analyte is deposited on the hydrogel and then analyzed by the laser desorption process without further application of matrix, as in traditional MALDI.

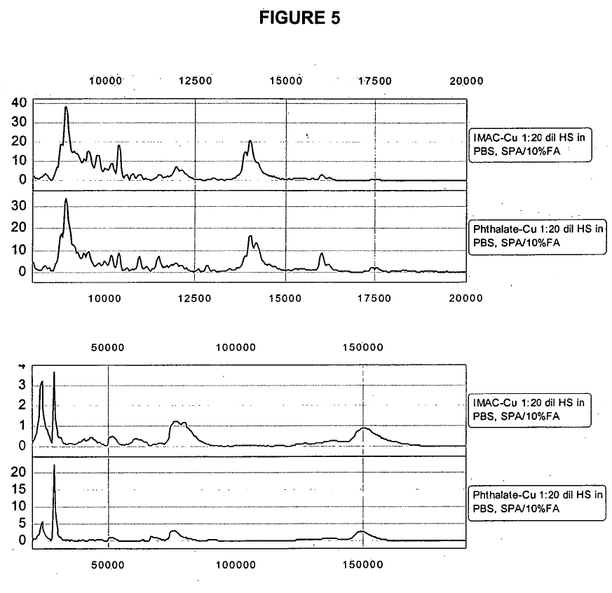

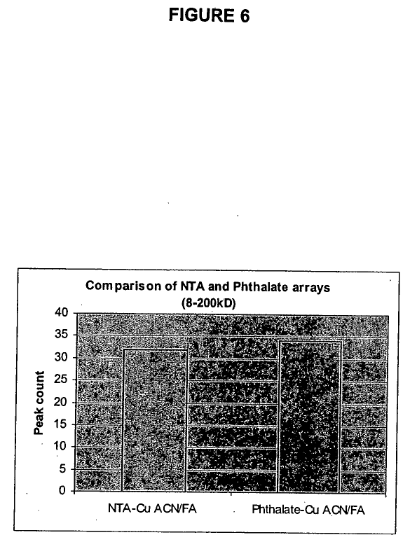

In an exemplary method, the chip is used to detect, via mass spectrometry, components in a peptide sample. FIG. 5 displays the mass spectra of a sample of albumin depleted human serum. The bar graphs of FIG. 6 display the changes in the number of peaks detected as the salt concentration of a sample of albumin depleted human serum is increased.

Fluorescence and Luminescence

For the detection of low concentrations of analytes in the field of diagnostics, the methods of chemiluminescence and electrochemiluminescence are widely accepted. Thus, the polymers and devices of the invention are of use in methods in which one or more assay component or region of the chip is bears a fluorescent or luminescent probe. Many fluorescent labels are commercially available. Furthermore, those of skill in the art will recognize how to select an appropriate fluorophore for a particular application and, if it not readily available commercially, will be able to synthesize the necessary fluorophore de novo or synthetically modify commercially available fluorescent compounds to arrive at the desired fluorescent label.

In addition to small molecule fluorophores, naturally occurring fluorescent proteins and engineered analogues of such proteins are useful in the present invention. Such proteins include, for example, green fluorescent proteins of cnidarians (Ward et al., Photochem. Photobiol. 35:803-808 (1982); Levine et al., Comp. Biochem. Physiol., 72B:77-85 (1982)), yellow fluorescent protein from Vibrio fischeri strain (Baldwin et al., Biochemistry 29:5509-15 (1990)), Peridinin-chlorophyll from the dinoflagellate Symbiodinium sp. (Morris et al., Plant Molecular Biology 24:673:77 (1994)), phycobiliproteins from marine cyanobacteria, such as Synechococcus, e.g., phycoerythrin and phycocyanin (Wilbanks et al., J Biol. Chem. 268:1226-35 (1993)), and the like.

Microscopic methods

Microscopic techniques of use in practicing the invention include, but are not limited to, simple light microscopy, confocal microscopy, polarized light microscopy, atomic force microscopy (Hu et al., Langmuir 13:5114-5119 (1997)), scanning tunneling microscopy (Evoy et al., J Vac. Sci. Technol A 15:1438-1441, Part 2 (1997)), and the like.

Spectroscopic methods

Spectroscopic techniques of use in practicing the present invention include, for example, infrared spectroscopy (Zhao et al., Langmuir 13:2359-2362 (1997)), raman spectroscopy (Zhu et al., Chem. Phys. Lett. 265:334-340 (1997)), X-ray photoelectron spectroscopy (Jiang et al., Bioelectroch. Bioener. 42:15-23 (1997)) and the like. Visible and ultraviolet spectroscopies are also of use in the present invention.

Assays

Retentate chromatography is among the assays in which the polymers and devices of the invention find use. Retentate chromatography has many uses in biology and medicine. These uses include combinatorial biochemical separation and purification of analytes, protein profiling of biological samples, the study of differential protein expression and molecular recognition events, diagnostics and drug discovery.

Retentate chromatography can include exposing a sample to a combinatorial assortment of different adsorbent/eluant combinations and detecting the behavior of the analyte under the different conditions. This both purifies the analyte and identifies conditions useful for detecting the analyte in a sample. Substrates having adsorbents identified in this way can be used as specific detectors of the analyte or analytes. In a progressive extraction method, a sample is exposed to a first adsorbent/eluant combination and the wash, depleted of analytes that are adsorbed by the first adsorbent, is exposed to a second adsorbent to deplete it of other analytes. Selectivity conditions identified to retain analytes also can be used in preparative purification procedures in which an impure sample containing an analyte is exposed, sequentially, to adsorbents that retain it, impurities are removed, and the retained analyte is collected from the adsorbent for a subsequent round. See, for example, U.S. Pat. No. 6,225,047.

Assays using a polymer of the invention, e.g., chip-based assays based on specific binding reactions are useful to detect a wide variety of targets such as drugs, hormones, enzymes, proteins, antibodies, and infectious agents in various biological fluids and tissue samples. In general, the assays consist of a target that binds to the chelating moiety of the polymer and a means of detecting the target after its immobilization by the chelating moiety (e.g., a detectable label, SELDI, SEND, MALDI, etc.).

The present invention provides a chip useful for performing assays that are useful for confirming the presence or absence of a target in a sample and for quantitating a target in a sample. An exemplary assay format with which the invention can be used is an immunoassay, e.g., competitive assays, and sandwich assays. Those of skill in the art will appreciate that the invention described herein can be practiced in conjunction with a number of other assay formats.

The chip and method of the present invention are also of use in screening libraries of compounds, such as combinatorial libraries.

Analytes

The methods of the present invention are uesful to detect any target, or class of targets, which interact with a binding fimctionality in a detectable manner. Exemplary target molecules include biomolecules such as a polypeptide (e.g., peptide or protein), a polynucleotide (e.g., oligonucleotide or nucleic acid), a carbohydrate (e.g., simple or complex carbohydrate) or a lipid (e.g., fatty acid or polyglycerides, phospholipids, etc.).

The target can be derived from any sort of biological source, including body fluids such as blood, serum, saliva, urine, seminal fluid, seminal plasma, lymph, and the like. It also includes extracts from biological samples, such as cell lysates, cell culture media, or the like. For example, cell lysate samples are optionally derived from, e.g., primary tissue or cells, cultured tissue or cells, normal tissue or cells, diseased tissue or cells, benign tissue or cells, cancerous tissue or cells, salivary glandular tissue or cells, intestinal tissue or cells, neural tissue or cells, renal tissue or cells, lymphatic tissue or cells, bladder tissue or cells, prostatic tissue or cells, urogenital tissues or cells, tumoral tissue or cells, tumoral neovasculature tissue or cells, or the like.

The target can be labeled with a fluorophore or other detectable group either directly or indirectly through interacting with a second species to which a detectable group is bound. When a second labeled species is used as an indirect labeling agent, it is selected from any species that is known to interact with the target species. Exemplary second labeled species include, but are not limited to, antibodies, aptazymes, aptamers, streptavidin, and biotin.

Methods of Making

In another exemplary embodiment, the invention provides a method of making a device of the invention. The method includes contacting a substrate with a chelating polymer described herein, such that the chelating polymer is immobilized on the substrate.

In another embodiment, the invention provides a method for making a plurality of adsorbent devices. Each member of the plurality of devices includes: (a) a solid support having a surface; and (b) an adsorbent chelating polymer film reversibly or irreversibly immobilized on the surface. In a preferred method, each solid support is contacted with an aliquot of the chelating polymer sampled from a single batch of the chelating polymer. The solid-support chelating polymer construct is optionally irradiated with UV radiation, to immobilize the polymer on the solid support's surface.

In an exemplary embodiment, the chelating polymer is immobilized on the substrate at a plurality of addressable locations.

The use of a single batch of polymer minimizes chip-to-chip and lot-to-lot variations. A preferred size for a single batch of the polymer is from about 0.5 liters and 5 liters. The single batch is preferably of sufficient volume to prepare a total area of addressable locations of least about 500,000 mm², preferably from about 500,000 mm² to about 50,000,000 mm², more preferably from about 100,000 to about 5,000,000 addressable locations.

As discussed above, the solid support optionally includes a linker arm that interacts with the chelating polymer. Thus, in an exemplary embodiment, a slurry of the chelating polymer is aliquoted onto the solid support surface at the location of the previously grafted linker arm. The slurry of particles is allowed to react for a selected period of time and then the residual unattached chelating polymer is simply rinsed away.

The following examples are provided to illustrate selected embodiments of the invention and are not to be construed as limiting its scope.

### EXAMPLES

### Example 1

### Preparation of a Silane Layer on an SiO₂-coated Aluminum Surface by Chemical Vapor Deposition (CVD) Process

A SiO₂-coated aluminum substrate was chemically cleaned with 0.01N HCl and methanol in an ultrasonic bath for 20 min. After wet cleaning, the aluminum substrates were further cleaned with a UV/ozone cleaner for 30 min. For CVD silanation, the SiO₂-coated aluminum substrates were placed in a reaction chamber along with 3-(trimethoxysilyl)propyl methacrylate (Aldrich). The chamber was evacuated under vacuum, the silane was vaporized and reacted with the surface. The reaction was maintained for 48 h. See, FIG. 7.

The formation of methacrylate-coated silane layer on the surface was confirmed with surface reflectance FTIR and contact angle measurements.

### Example 2

### Preparation of 4-Benzoyl-N-[3-(2-methyl-acryloylamino)-propyl]- benzamide Monomer

THF (80 mL), N-(3-aminopropyl)methacrylamide hydrochloride (4.82 g;olysciences, Warrington, Pa.), 4-benzoylbenzoic acid (6.10 g; Aldrich), 3-dicyclohexylcarbodiimide (DCC) (5.60 g), dimethyaminopyridine (0.4 g), and triethylamine (5.5 g) were combined in a dry, 250-mL round bottom flask, equipped with a magnetic stirrer. The solution was cooled with an ice bath and stirred for 3 h. The ice bath was removed and the solution was stirred at room temperature overnight. The precipitates were filtered off and the solvent was evaporated. The residue was re-dissolved in CHCl₃. The solution deionized water (3×). The chloroform was removed and the crude product was recrystallized from chloroform/toluene, to give about 60% total yield of the product. ¹H NMR confirmed the formation of the desired product. See, FIG. 2.

### Example 3

### Preparation of Copolymer of Mono-2-(methacryloyloxy)ethyl phthalate Monomer, Acryloyltri(hydroxymethyl)methylamine (TriHMA) and 4-Benzoyl-N-[3-(2-methyl-acryloylamino)-propyl]-benzamide Monomer

To prepare a photocrosslinkable chelating copolymer having benzophenone along the polymer backbone (FIG. 3), 4.23 g of mono-2-(methacryloyloxy)ethyl phthalate monomer (Aldrich, CAS # 27697-00-3) and 4.15 g of acryloyltri(hydroxymethyl)methylamine (TriHMA) (Aldrich) was mixed with 20.0 mL of N,N-dimethylformamide, followed with 0.266 g of 4-benzoyl-N-[3-(2-methyl-acryloylamino)-propyl ]-benzamide, and 0.01 g of lauroyl peroxide initiator. The solution was purged with a flow of argon for five min. The vessel was sealed and then heated at 58° C. for 24 h. After polymerization, the solution became viscous. The solution was poured into a large amount of ethyl acetate to precipitate the polymer. The polymer powder was further washed with ethyl acetate several times, and dried under vacuum.

### Example 4

### Preparation of Copolymer of Mono-2-(methacryloyloxy)ethyl phthalate Monomer, Acryloyltri(hydroxymethyl)methylamine (TriHMA) and 4-Benzoyl-N-[3-(2-methyl-acryloylamino)-propyl]-benzamide Monomer

6.12 g of mono-2-(methacryloyloxy)ethyl phthalate monomer (Aldrich, CAS # 27697-00-3) and 4.15 g of acryloyltri(hydroxymethyl)methylamine (TriHMA) (Aldrich) was mixed with 30.0 mL of N,N-dimethylformamide, followed with 0.512 g of 4-benzoyl-N-[3-(2-methyl-acryloylamino)-propyl]-benzamide, and 0.013 g of lauroyl peroxide initiator. The solution was purged with a flow of argon for five minutes. The vessel was sealed and then heated at 58° C. for 24 hours. After polymerization, the solution became viscous. The solution was poured into a large amount of ethyl acetate to precipitate off the polymer. The polymer powder was further washed with ethyl acetate for several times, and dried under vacuum.

### Example 5

### Preparation of Phthalate-TriHMA Surface Coatings

To prepare phthalate-TriHMA hydrogel coatings, the above phthalate-TriHMA copolymers were dissolved in DI water. The solution was dispensed on the surface of methacrylate-coated SiO₂ aluminum substrates. After drying, the polymer-coated chips were exposed for 20 min. to UV light of a wavelength of approximately 360 nm (Hg short arc Lamp, 20 mW/cm² at 365 nm). Reflectance FTIR results confirmed the formation of a chelating polymer hydrogel coating on the surface of aluminum substrates (FIG. 4).

### Example 5

### Preparation of Copolymer by Complexing with a Metal Ion

To use the array for protein capturing and SELDI analysis, the phthalate chips were loaded with copper or nickel before protein samples were applied (FIG. 1).

For instructions for using ProteinChip, see, for example, WO 00/66265 (Rich et al., “Probes for a Gas Phase Ion Spectrometer,” Nov. 9, 2000). The following is an exemplary protocol for profiling on the phthalate arrays. Nitrilotriacetic acid-based IMAC chips were used as control. The control chip is commercially available from Ciphergen Biosystems. Inc.

5.1 Copper Protocol

A copper sulfate solution (5 μL of 0.1 M) was added to each spot on the chip array. The chip was incubated in a humidity chamber for 15 min. The solution was removed from the spots and the array was rinsed with deionized water. To each spot was added an excess of 0.1 M sodium acetate, pH 4.0 and the chip was vortexed for 5 min. The solution was removed from the spots and the array was rinsed with deionized water. To each spot was applied 5 μL of 0.1 M sodium phosphate/0.5 M NaCl binding solution. The chip was incubated on a shaker for 5 min. The binding buffer solution was removed. To each spot was added 5 μL of albumin depleted human serum (diluted 20X in binding buffer) and the chip was incubated in a humidity chamber for 1 hour at room temperature on a shaker. The serum was removed and each spot was washed with 5 μL of binding buffer for 5 min on a shaker at room temperature. The wash step was repeated twice. The chip was rinsed with DI water. 1 μL of SPA matrix solution (˜5 mg of SPA is dissolved in 200 μL of 100% acetonitrile +143 μL DI water +57 μL of 70% formic acid) was added to each spot. The chip was dried and read in PBSIIc instrument.

FIG. 5 shows the composite mass spectrum at low and high molecular mass of albumin depleted human serum proteins recognition profile. The profiling spectrum of the phthalate chip was compared to that of the nitrilotriacetic acid-based IMAC chips. The profile indicates that the analyte capture performance of the phthalate chip is comparable to a nitrilotriacetic acid-based IMAC chip.

FIG. 6 is a SELDI peak count comparison of albumin depleted human serum profiling of the phthalate surface array with the nitrilotriacetic acid (NTA) surface array.

All publications and patent documents cited in this application are incorporated by reference in their entirety for all purposes to the same extent as if each individual publication or patent document were so individually denoted. By their citation of various references in this document, Applicants do not admit any particular reference is “prior art” to their invention.

What is claimed is:

1. A polymer comprising linked monomeric subunits wherein a plurality of said monomeric subunits are chelating subunits having the formula: 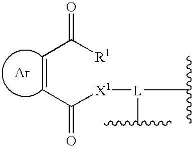
wherein
Ar is a member selected from aryl and heteroaryl;
X¹ is a member selected from O and NR²
wherein
R² is a member selected from H, substituted or unsubstituted alkyl and substituted or unsubstituted heteroalkyl;
R¹ is a member selected from O⁻, OR³ and NR³R⁴
wherein
R³ and R⁴ are members independently selected from H, substituted or unsubstituted alkyl and substituted or unsubstituted heteroalkyl; and
L is a linker that links said chelating subunit to monomeric subunits in the polymer and is a member selected from carbon, substituted or unsubstituted alkyl and substituted or unsubstituted heteroalkyl, comprising a bond to at least one other monomeric subunit of said polymer.

2. The polymer according to claim 1 wherein said at least one other monomeric subunit of said polymer is a member selected from another of said plurality of chelating subunits, a non-chelating subunit comprising a hydrophilic moiety, a non-chelating subunit comprising a UV curable moiety and a non-chelating subunit comprising an energy absorbing moiety.

3. The polymer according to claim 1 wherein
R¹ is O⁻; and
X¹ is O.

4. The polymer according to claim 1 wherein Ar is substituted or unsubstituted phenyl.

5. The polymer according to claim 1 further comprising a metal ion chelated by at least one of said metal chelating subunits.

6. The polymer according to claim 5 wherein said metal ion is a member selected from an ion of copper, iron, nickel, colbalt, gallium and zinc.

7. The polymer according to claim 5, further comprising an analyte bound to said polymer through an interaction with said metal ion.

8. The polymer according to claim 7 wherein said analyte is a member selected from an oligonucleotide and a peptide.

9. The polymer according to claim 1 wherein L comprises a moiety having the formula: [symbol] —(CH₂)ₘO— [symbol]
wherein
m is an integer from 1 to 10.

10. The polymer according to claim 1 wherein said UV curable moiety is a member selected from a benzophenone, a diazoester, an arylazide and a diazirine.

11. The polymer according to claim 10 wherein said non-chelating subunit comprising a UV curable moiety has the formula: 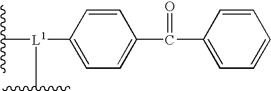
wherein
L¹ is a linker that links said chelating subunit to other monomeric subunits in the polymer and is a member selected from carbon, substituted or unsubstituted alkyl and substituted or unsubstituted heteroalkyl, comprising a bond to at least one other monomeric subunit of said polymer.

12. The polymer according to claim 11 wherein L¹ comprises a moiety having the formula: [symbol]
—NH(CH₂)ₜNHC(O)— [symbol]
wherein
t is an integer from 1 to 10.

13. The polymer according to claim 1 wherein said energy absorbing molecule comprises the structure: 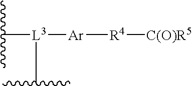
wherein
Ar is a member selected from substituted or unsubstituted aryl and substituted or unsubstituted heteroaryl;
R⁴ is a member selected from a bond, substituted or unsubstituted alkyl and substituted or unsubstituted heteroalkyl;
R⁵ is a member selected from H, OH and substituted or unsubstituted alkyl; and
L³ is a linker that links said chelating subunit to other monomeric subunits in the polymer and is a member selected from carbon, substituted or unsubstituted alkyl and substituted or unsubstituted heteroalkyl, comprising a bond to at least one other monomeric subunit of said polymer.

14. The polymer according to claim 13 wherein Ar is a member selected from substituted or unsubstituted phenyl, substituted or unsubstituted indolyl and substituted or unsubstituted pyridyl.

15. The polymer according to claim 14, wherein Ar is a member selected from: 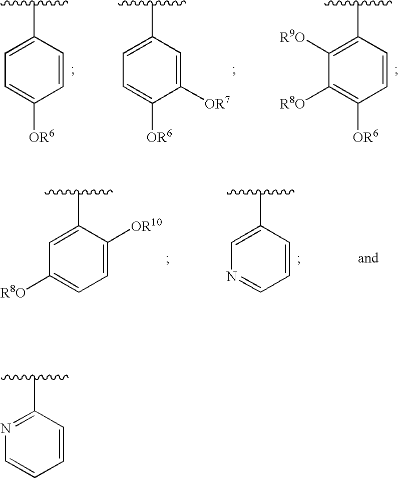
wherein
R⁶, R⁷, R⁸, R⁹ and R¹⁰ are members independently selected from H and substituted or unsubstituted alkyl.

16. The polymer according to claim 15 wherein R⁶, R⁷, R⁸, R⁹ and R¹⁰ are members independently selected from H and C₁-C₆ unsubstituted alkyl.

17. The polymer according to claim 13 wherein R⁴ has the formula: [symbol]
—CR¹¹═CR¹²— [symbol]
wherein
R¹¹ and R¹² are members independently selected from H, substituted or unsubstituted alkyl, substituted or unsubstituted heteroalkyl, and CN.

18. The polymer according to claim 17 wherein R⁴ has a formula that is a member selected from:

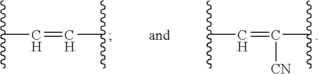

19. The polymer according to claim 1, comprising a polymeric unit having the formula: 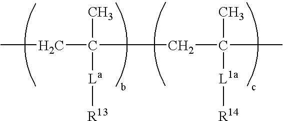
wherein
L^{a} and L^{1a} are linkers independently selected from a bond, substituted or unsubstituted alkyl and substituted or unsubstituted heteroalkyl moieties;
the subunit having the formula: 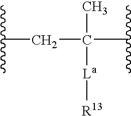
is said chelating subunit
wherein
R¹³ is a chelating moiety having the formula: 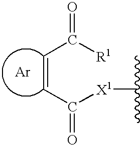
the subunit having the formula: 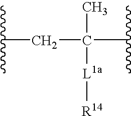
is a member selected from said subunit comprising a hydrophilic moiety, said subunit comprising a UV curable moiety and said subunit comprising an energy absorbing moiety;
wherein
R¹⁴ is a member selected from said hydrophilic moiety, said UV curable moiety and said energy absorbing moiety; and
b and c are independently selected numbers from 0.01 to 0.99, such that (b+c) is 1.

20. The polymer according to claim 19 wherein said polymeric unit has the formula: 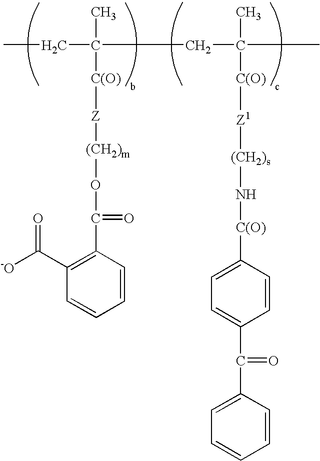
wherein
Z and Z¹ are members independently selected from a bond, O, NH and S; and m and s are independently selected from the integers from 1 to 10.

21. The polymer according to claim 1, comprising a polymeric unit having the formula: 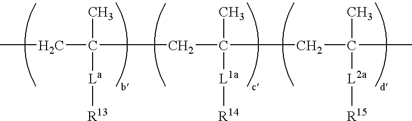
wherein
La, L^{1a} and L^{2a} are linkers independently selected from a bond, substituted or unsubstituted alkyl and substituted or unsubstituted heteroalkyl moieties;
the subunit having the formula: 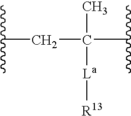
is said chelating subunit
wherein
R¹³ is a chelating moiety having the formula: 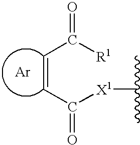
the subunits having the formulae: 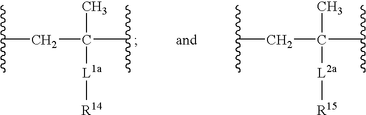
are members independently selected from said subunit comprising a hydrophilic moiety, said subunit comprising a UV curable moiety and said subunit comprising an energy absorbing moiety;
wherein
R¹⁴ and R¹⁵ are members independently selected from said hydrophilic moiety, said UV curable moiety and said energy absorbing moiety; and
b′, c′ and d′ are independently selected numbers from 0.01 to 0.99, such that (b′+c′+d′)=1.

22. The polymer according to claim 21, having the formula: 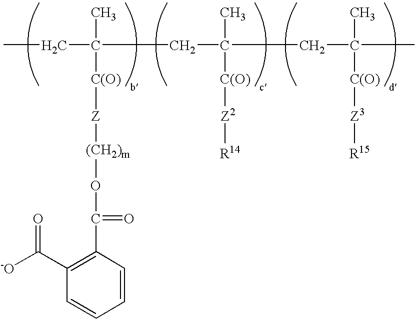
wherein
Z. Z² and Z³ are members independently selected from a bond, O. S and NH; m is a n integer from 1 to 10;
b′, c′ and d′ are independently selected numbers from 0.01 to 0.99, such that (b+c+d)=1; and
R¹⁴ and R¹⁵ are members independently selected from:

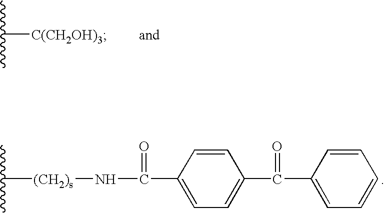

23. The polymer according to claim 1 wherein an analyte is immobilized on said polymer by interacting with a metal ion chelated by said chelating subunit.

24. A kit comprising:
(a) a polymer according to claim 1; and
(b) a substrate comprising means for engaging a probe interface of a mass spectrometer.

25. A device comprising a substrate having a surface comprising a polymer chemisorbed or physisorbed to said surface, said polymer comprising linked monomeric subunits wherein a plurality of said monomeric subunits are chelating subunits having the formula: 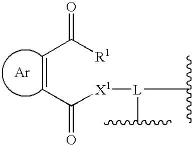
wherein
Ar is a member selected from aryl and heteroaryl;
X¹ is a member selected from 0 and NR²
wherein
R² is a member selected from H, substituted or unsubstituted alkyl and substituted or unsubstituted heteroalkyl;
R¹ is a member selected from O⁻, OR³ and NR³R⁴
wherein
R³ and R⁴ are members independently selected from H, substituted or unsubstituted alkyl and substituted or unsubstituted heteroalkyl; and
L is a linker that links said chelating subunit to other monomeric subunits in the polymer and is a member selected from carbon, substituted or unsubstituted alkyl and substituted or unsubstituted heteroalkyl, comprising a bond to at least one other monomeric subunit of said polymer.

26. The device according to claim 25, further comprising an analyte adsorbed onto said polymer.

27. The device according to claim 26, further comprising a laser desorption/ionization matrix contacting said analyte.

28. The device according to claim 26 wherein said analyte is adsorbed onto said molecular host through an interaction between said analyte and said chelating moiety of said polymer.

29. The device according to claim 25 wherein said substrate comprises means for engaging a probe interface of a mass spectrometer.

30. The device according to claim 25 wherein said polymer is distributed on said substrate in a plurality of addressable locations.

31. A method of detecting an analyte comprising:
(a) binding an analyte to a device comprising a substrate derivatized with a polymer comprising chelating moieties, said polymer comprising linked monomeric subunits wherein a plurality of said monomeric subunits are chelating subunits having the formula: 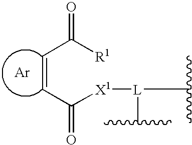
wherein
Ar is a member selected from aryl and heteroaryl;
X¹ is a member selected from O and NR²
wherein
R² is a member selected from H, substituted or unsubstituted alkyl and substituted or unsubstituted heteroalkyl;
R¹ is a member selected from O⁻, OR³ and NR³R⁴
wherein
R³ and R⁴ are members independently selected from H, substituted or unsubstituted alkyl and substituted or unsubstituted heteroalkyl; and
L is a linker that links said chelating subunit to other monomeric subunits in the polymer and is a member selected from carbon, substituted or unsubstituted alkyl and substituted or unsubstituted heteroalkyl, comprising a bond to at least one monomeric subunit of said polymer; and
(b) detecting the bound analyte.

32. The method according to claim 31 wherein said device is a probe for mass spectrometry; and said detecting is by matrix-assisted laser desorption ionization mass spectrometry.

33. The method of claim 31 comprising detecting said analyte by laser desorption/ionization mass spectrometry.

34. The method of claim 31 further comprising:
(c) contacting said analyte with a laser desorption/ionization matrix that absorbs energy from a photo-irradiation source and transfers said energy to an analyte with which it is in operative contact, thereby promoting desorption and ionization of said analyte.
